(19) United States
(12) Patent Application Publication
(10) Pub. No.: US 2010/0259413 A1
(43) Pub. Date: Oct. 14, 2010

(54) LOCATION MANAGEMENT SYSTEM FOR MOVING OBJECT AND LOCATION MANAGEMENT METHOD FOR MOVING OBJECT

(75) Inventor: Soo-Sun Kim, Busan (KR)

Correspondence Address: WENDEROTH, LIND & PONACK, L.L.P., 1030 15th Street, N.W.,, Suite 400 East, Washington, DC, 20005-1503, US

(73) Assignee: Chang San It Co., Ltd.

(21) Appl. No.: 12/734,478

(22) PCT Filed: Aug. 21, 2008
(86) PCT No.: PCT/KR2008/004891

§ 371 Date: May 4, 2010

(30) Foreign Application Priority Data
Nov. 5, 2007 (KR) 10-2007-0111914

(51) Int. Cl. G08B 5/22; G01S 19/42

(52) U.S. Cl. 340/825.49; 342/357.25

(57) ABSTRACT

A system and method for managing the location of at least one moving object is disclosed. An object movement detection unit is configured to be provided on the moving object, and to detect the movement of the moving object. A wireless tag is configured to be provided on the moving object, and to wirelessly transmit Identification (ID) information based on information about the movement of the moving object which is detected by the object movement detection unit. A location information generation unit is configured to be provided on the transporting object, and to generate the location information of the transporting object. A moving object location information generation unit is configured to generate location information of the moving object using the ID information wirelessly transmitted from the wireless tag and the location information generated by the location information generation unit.

### TECHNICAL FIELD

The present invention relates to a method and system for detecting and managing the location of at least one moving object being moved by a transporting object. Here, the transporting object is a crane or a hoist which is used to move an article, and the moving object is an article which is being moved by the transporting object.

### BACKGROUND ART

With regard to a method of detecting the location of an object, a location detection method using a Global Positioning System (GPS) has been widely used.

With regard to a location detection method using a GPS, Differential Global Positioning System (DGPS) technology, which is a relative positioning method for applying errors, included in data measured at a reference point, to data measured at a location spaced apart from the reference point, and then performing correction, has been widely used as well as general GPS technology for directly measuring a location using information about distance measured by an artificial satellite.

In the foregoing and following descriptions, the term ‘GPS’ includes all types of technologies, for example, DGPS for measuring a location by correcting GPS information as well as general GPS.

Since the location detection method using GPS requires that GPS receivers should be attached to all objects, the locations of which are desired to be detected, it is difficult to apply the location detection method using GPS due to the problem of costs when there are a lot of objects, the locations of which should be detected.

Meanwhile, a plurality of items of freight or containers has been loaded in a storehouse or an open-air yard, and the locations of them are required to be managed.

Currently, with regard to a method of managing the locations of items of freight or containers, a method of locating designated items of freight or containers at a location previously designated by a computer and then managing information thereabout, and a method of moving items of freight or containers to a predetermined location and then inputting the location into a computer by hand have been widely used.

### DISCLOSURE

### Technical Problem

Accordingly, the present invention has been made keeping in mind the above problems occurring in the prior art, and an object of the present invention is to provide a system and method for detecting and managing the location of at least one moving object, regardless of the name thereof, such as an item of freight, a packaging box, or a container, being moved by any type of a transporting object, for example, a crane, a hoist, a forklift truck, a truck, or a vehicle.

### Technical Solution

In order to accomplish the above object, the present invention provides a moving object location management system for managing the location of at least one moving object being moved by a transporting object, the system including an object movement detection unit configured to be provided on the moving object, and to detect the movement of the moving object; a wireless tag configured to be provided on the moving object, and to wirelessly transmit Identification (ID) information based on information about the movement of the moving object which is detected by the object movement detection unit; a location information generation unit configured to be provided on the transporting object, and to generate the location information of the transporting object; and a moving object location information generation unit configured to generate the location information of the moving object using the ID information wirelessly transmitted from the wireless tag and the location information generated by the location information generation unit.

According to another aspect of the present invention, the present invention provides a moving object location management method of managing the location of at least one moving object being moved by a transporting object, the method including an object movement detection unit, provided on the moving object, detecting the movement of the moving object; a wireless tag, provided on the moving object, wirelessly transmitting ID information based on information about the detected movement of the moving object; a location information generation unit, provided on the transporting object, generating the location information of the transporting object; and a moving object location information generation unit generating the location information of the moving object using the ID information and the location information of the transporting object.

### Advantageous Effects

According to the present invention, the locations of moving objects being moved by a transporting object can be easily managed at a very low cost, so that an automated location management method for moving objects can be popularized.

### DESCRIPTION OF DRAWINGS

FIG. 1 is a diagram showing the concept of an embodiment according to the present invention; and

FIGS. 2 and 3 are schematic diagrams showing states to which the embodiment of FIG. 1 is applied.

### DESCRIPTION OF REFERENCE NUMERALS OF PRINCIPAL ELEMENTS IN THE DRAWINGS

110: object movement detection unit

120: wireless tag

210: location information generation unit

220: moving object location information generation unit

230: transporting object transmission unit

300: central control unit

### BEST MODE

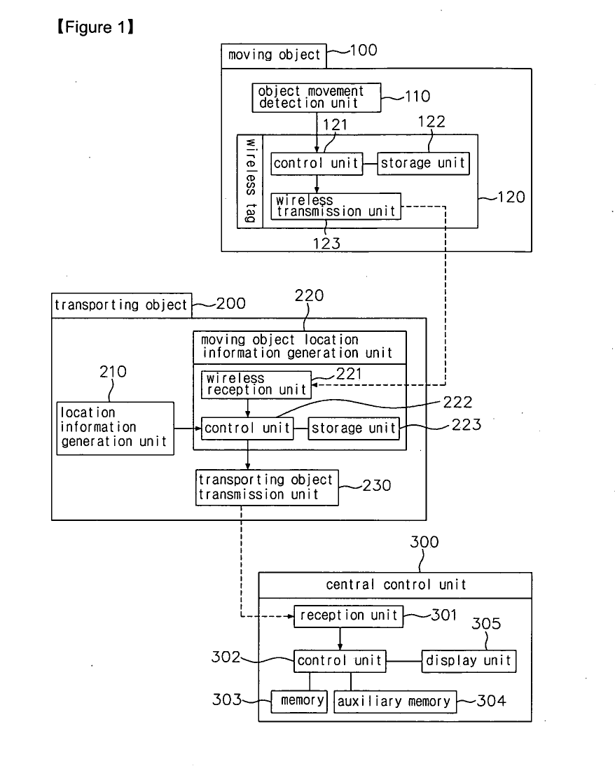

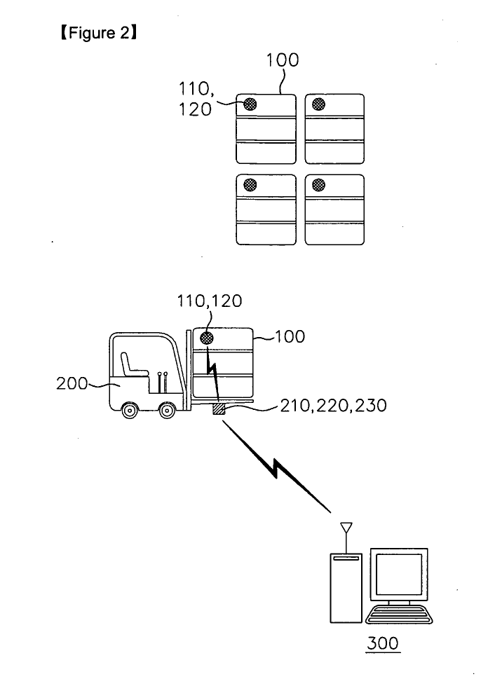

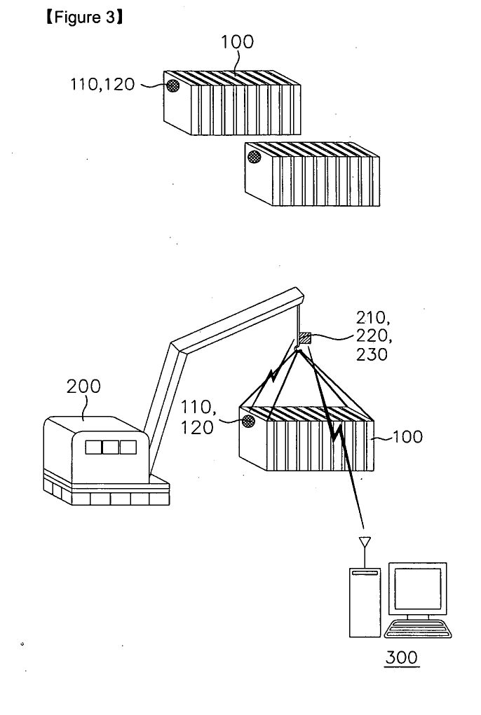

An embodiment according to the present invention will be described in detail below. FIG. 1 is a diagram showing the concept of an embodiment according to the present invention, and FIGS. 2 and 3 are schematic diagrams showing states to which the system of FIG. 1 is applied.

First, a moving object 100 is provided with an object movement detection unit 110 and a wireless tag 120.

The moving object 100 includes all objects which can be moved by a transporting object 200, which will be described later, regardless of the names of the objects, such as an item of freight, a packaging box, and a container.

The object movement detection unit 110 is used to detect the movement of the moving object 100, and may employ an acceleration sensor or a mercury sensor.

Therefore, when the moving object 100 moves, the object movement detection unit 110 detects the movement and then notifies the wireless tag 120, which will be described later, of the fact that the moving object 100 moves.

The wireless tag 120 transmits ID information stored in the storage unit 122, such as memory, to the moving object location information generation unit 220, which will be described later, through the wireless transmission unit 123.

The ID information, stored in the storage unit 122, may include any type of ID information as long as the ID information can be used to identify the moving object 100 to which a relevant wireless tag 120 is attached.

The control unit 121 of the wireless tag 120 analyzes information about the movement of an object, detected by the movement detection unit 110, determines a time to transmit the ID information, and then transmits the ID information based on the determination.

For example, the control unit 121 can perform control such that ID information is continuously transmitted while the object movement detection unit 110 detects the movement of the moving object 100. However, this method is not preferable because this method not only increases communication traffic but also rapidly increases power consumption when the wireless tag 120 is operated by the power. Further, depending on the situation, since the object movement detection unit 110 may react to small shocks that the moving object 100 may receive, it is preferable that a signal attributable to the small shocks be classified as abnormal movement and that ID information be not transmitted.

Therefore, it is preferable that the control unit 121 of the wireless tag 120 analyze information about the movement of the moving object 110 detected by the object movement detection unit 110, and perform control such that ID information is transmitted only when the information about the movement of the moving object 110 is appropriate to a predetermined reference. With regard to the algorithm for analyzing the information of the object movement detection unit 110, various algorithms may be applied.

Therefore, among a plurality of moving objects 100, only the wireless tag 120 of the moving object 100 being moved by the transporting object 200 transmits ID information, and the wireless tags 120 of the remaining moving objects 100 which remain stationary, namely do not transmit any signal.

The ID information transmitted by the moving object 100 which is being moved is received by the moving object location information generation unit 220 of the transporting object 200.

In this embodiment, the transporting object 200 includes a location information generation unit 210, a moving object location information generation unit 220, and a transporting object transmission unit 230.

The location information generation unit 210 is used to generate the location information of the transporting object 200. Further, since the location information of the transporting object 200 generated by the location information generation unit 210 is finally utilized as the location information of the moving object 100, it is preferable that the location information generation unit 210 be provided in the portion of the transporting object 200 such that the location information generation unit 210 has the same movement as the moving object 100. For example, in the case of a forklift truck, it is preferable that the location information generation unit 210 be provided on each of the legs of the forklift truck, and, in the case of a crane or hoist, it is preferable that the location information generation unit 210 be provided on a hook or around the hook.

Since these portions maintain predetermined location relationship with the moving object 100, the location of the moving object 100 can be easily, comparatively, and correctively calculated if the location of the location information generation unit 210 is detected.

Although there are various technologies of the location information generation unit 210 measuring its own location and then generating location information, a method of measuring a location using GPS is preferable in so far as another device is not necessary. Therefore, it is preferable that the location information generation unit 210 be a GPS receiver for generating GPS information.

Of course, in the foregoing and following descriptions, the GPS information includes GPS information to which not only general GPS technology but also DGPS technology are applied so as to improve accuracy.

Further, since a GPS receiver obtains not only distance information but also time information from satellites, the GPS receiver is preferable in so far as not only simple location information but also time information can be generated.

In this embodiment, the moving object location information generation unit 220 may be a type of wireless tag reader, and be provided in the transporting object 200.

The moving object location information generation unit 220 receives ID information, transmitted by the wireless transmission unit 123 of the wireless tag 120, through the wireless reception unit 221.

Further, when the control unit 222 of the moving object location information generation unit 220 receives the ID information through the wireless reception unit 221, the control unit 222 receives location information from the location information generation unit 210, combines the ID information with the location information, and then generates location information of the moving object 100.

That is, the location information of the moving object 100, generated as described above, has a type with which the ID information of the moving object 100, the time information generated using the GPS information, and the location information are combined.

Of course, the time information may not be used depending on embodiments.

Further, instead of original location information generated based on the GPS information, new location information, which is corrected in consideration of the relationship between the location of the location information generation unit 210 and the location of the moving object 100, may be generated as the location information of the moving object 100.

The location information of the moving object 100, generated as described above, may be directly transmitted to the central control unit 300 through the transporting object transmission unit 230 which is connected to the moving object location information generation unit 220, or may be temporarily stored in the storage unit 223 and then transmitted to the central control unit 300 at predetermined time intervals.

In the case in which the location information of the moving object 100 is directly transmitted to the central control unit 300, there is an advantage in that the location of the moving object 100 can be detected and managed in real time but there is a disadvantage in that traffic may be induced.

Therefore, if the location information of the moving object 100 is not required to be managed in real time, it is preferable that the location information of the moving object 100, stored in the storage unit 223 in order to reduce traffic, be transmitted to the central control unit 300 at predetermined time intervals (for example, at one minute to three minute intervals).

Further, a method of transmitting only the start location and termination location of movement of the moving object 100, without transmitting all the location information of the moving object 100 based on time, may be considered depending on the situation. The central control unit 300 receives the location information of the moving object 100 through a reception unit 301 and manages the location information of the moving object 100 through a control unit 302, memory 303, auxiliary memory 304, and a display unit 305.

That is, with regard to a method of the central control unit 300 managing the location of the moving object 100, various methods, including a method of displaying the location of each of the moving objects 100 in the current state, a method of displaying the movement history of the moving object 100, and, if articles are stored in the moving object 100, a method of displaying the location of the moving object 100 in association with details of the stored articles, may be applied.

The above-described embodiment has been described such that the moving object location information generation unit 220 is provided in the transporting object 200. However, depending on embodiments, the moving object location information generation unit 220 may be provided separately from the transporting object 200. That is, although the location information generation unit 210 must be provided in the transporting object 200, as long as the moving object location information generation unit 220 can receive the ID information from the wireless tag 120 in a wireless manner, and can receive location information from the location information generation unit 210 in a wired/wireless manner, the location of the moving object location information generation unit 220 may vary if necessary.

The above-described embodiments are the preferred embodiments of the present invention, and the technical spirit of the present invention may be variously changed, adjusted, and then realized by those skilled in the art. If the modifications and adjustments use the technical spirit of the present invention, they are included in the scope of the present invention.

### INDUSTRIAL APPLICABILITY

The present invention may be used for a method and system for detecting and managing the location of at least one object, that is, a moving object, being moved by a transporting object such as a crane or a hoist. In particular, the present invention can be utilized to manage a storehouse or an open-air yard in which items of freight and containers are stored.

1. A system for detecting and managing the location of at least one moving object being moved by a transporting object, the system comprising:
an object movement detection unit configured to be provided on the moving object, and to detect movement of the moving object;
a wireless tag configured to be provided on the moving object, and to wirelessly transmit Identification (ID) information based on information about the movement of the moving object which is detected by the object movement detection unit;
a location information generation unit configured to be provided on the transporting object, and to generate location information of the transporting object; and
a moving object location information generation unit configured to generate location information of the moving object using the ID information wirelessly transmitted from the wireless tag and the location information generated by the location information generation unit.

2. The system according to claim 1, wherein the moving object location information generation unit is provided on the transporting object.

3. The system according to claim 2, wherein the moving object location information generation unit is connected to a transporting object transmission unit for transmitting the location information of the moving object,
further comprising a central control unit for receiving and managing the location information of the moving object transmitted from the transporting object transmission unit.

4. The system according to claim 1, wherein the location information generation unit is a Global Positioning System (GPS) receiver for generating GPS information.

5. The system according to claim 4, wherein the GPS receiver simultaneously generates location information and time information, and the moving object location information generation unit uses the time information, which is generated by the GPS receiver, when generating the location information of the moving object.

6. The system according to claim 1, wherein the object movement detection unit is an acceleration sensor.

7. A method for detecting and managing the location of at least one moving object being moved by a transporting object, the method comprising:
an object movement detection unit, provided on the moving object, detecting movement of the moving object;
a wireless tag, provided on the moving object, wirelessly transmitting ID information based on information about the detected movement of the moving object;
a location information generation unit, provided on the transporting object, generating location information of the transporting object; and
a moving object location information generation unit generating location information of the moving object using the ID information and the location information of the transporting object.

8. The method according to claim 7, wherein the moving object location information generation unit is provided on the transporting object.

9. The method according to claim 8, wherein a transporting object transmission unit, which is connected to the moving object location information generation unit, transmits the location information of the moving object to a central control unit, and the central control unit receives and manages the location information of the moving object.

10. The method according to claim 7, wherein the location information generation unit is a GPS receiver for simultaneously generating location information and time information, and the moving object location information generation unit uses the time information, which is generated by the GPS receiver, when generating the location information of the moving object.
